(19) United States
(12) Patent Application Publication
(10) Pub. No.: US 2016/0089898 A1
(43) Pub. Date: Mar. 31, 2016

(54) Printing on liquid medium using liquid ink

(71) Applicants: Hue P. Le, Beaverton, OR (US); Tai Ngoc Dang, Portland, OR (US); Tue Nguyen, Fremont, CA (US)

(72) Inventors: Hue P. Le, Beaverton, OR (US); Tai Ngoc Dang, Portland, OR (US); Tue Nguyen, Fremont, CA (US)

(21) Appl. No.: 14/867,005

(22) Filed: Sep. 28, 2015

Related U.S. Application Data
(60) Provisional application No. 62/056,630, filed on Sep. 29, 2014.

(51) Int. Cl. B41J 3/407; A23P 1/08

(52) U.S. Cl. CPC B41J 3/407; A23P 1/085; A23V 2002/00; A23P 2001/089

(57) ABSTRACT

Ink jet printing on a liquid medium can be performed using liquid inks having a thermo inversion gelling property. The liquid ink can include a hyperthermogelling component having a gelling temperature. When the liquid ink is jetted on the liquid medium, the liquid ink can gel to form gel dots. The gel dots can resist against liquid dispersion, allowing the formation of a high resolution image on the liquid medium.

The present application claims priority from U.S. Provisional Patent Application Ser. No. 62/056,630, filed on Sep. 29, 2014 entitled: “Printing on liquid medium using liquid ink” which are incorporated herein by reference.

### BACKGROUND

Automated printers using edible inks have been developed for printing on food products, e.g., printing directly on the food products, or separately printing on a sheet and placing it on the food products. The printing process typically uses liquid ink on solid or semi-solid surface, e.g., non-liquid medium, for example, a foam top surface of a liquid beverage, such as a foam milk portion of a coffee drink.

Direct printing of liquid ink on liquid surface can represent difficulty, since the liquid ink can disperse rapidly upon reaching the liquid medium, distorting the printed image. For example, an inherent problem associated with aqueous inks employed in liquid printing, e.g., printing a liquid ink on a liquid medium, is the dispersion of ink drops after placement onto the liquid medium. Dispersing can cause intercolor bleeding, poor resolution, and image degradation adversely affecting the print quality.

FIGS. 1A-1C illustrate a dispersion characteristic of a liquid ink on a liquid medium according to some embodiments. In FIGS. 1A and 1B, a liquid droplet 120 can be dropped on a liquid medium 110, for example, from an ink jet printer. As time progresses, the droplet 120 can disperse 130 in the liquid medium, e.g., becoming larger and more diluted droplets 122, 124, and 126. With time, the droplets can be diluted to cover the whole volume of the liquid medium.

In FIG. 1C, a liquid droplet 125 can be dropped on a foam surface 114 of a liquid medium 112. The liquid droplet 125 can be confined by the foam surface, thus allowing printing of liquid ink, e.g., minimizing the dispersion of the ink.

Thus there is a need for printing of liquid ink on a liquid medium with minimal dispersion.

### SUMMARY

In some embodiments, the present invention discloses methods and systems for printing on liquid beverages using edible liquid ink. The liquid ink can include a hyperthermogelling component having a gelling temperature. When the liquid ink is jetted on the liquid beverages, the liquid ink can gel to form gel dots. The gel dots can resist the liquid dispersion, allowing the formation of a high resolution image on the liquid medium.

### BRIEF DESCRIPTION OF THE DRAWINGS

FIGS. 1A-1C illustrate a dispersion characteristic of a liquid ink on a liquid medium according to some embodiments.

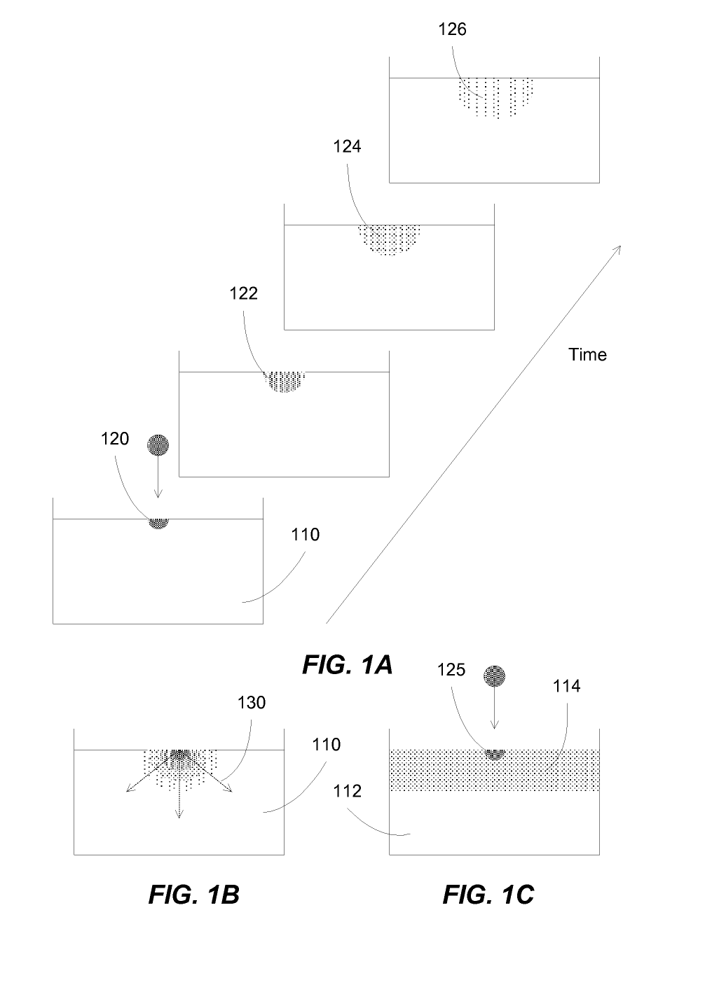

FIGS. 2A-2B illustrate schematic of printing using a phase change ink on a liquid medium according to some embodiments.

FIGS. 3A-3B illustrate flow charts for printing liquid phase change inks on liquid media according to some embodiments.

FIGS. 4A-4B illustrate properties of phase change inks according to some embodiments.

FIGS. 5A-5B illustrate flow charts for printing liquid phase change inks on liquid media according to some embodiments.

FIG. 6 illustrates a schematic of a printer for printing on a liquid according to some embodiments.

FIGS. 7A-7B illustrate flow charts for printing on liquid media according to some embodiments.

### DETAILED DESCRIPTION OF THE EMBODIMENTS

In some embodiments, the present invention discloses methods and systems for liquid printing on liquid media, such as on liquid beverages, using liquid inks, such as edible liquid inks The liquid ink can include a hyperthermogelling component, which can cause the liquid ink to gel, e.g., cross-link, at temperatures higher than a gelling temperature of the liquid ink mixture. Gel is a solid and jelly-like material. By weight, gels are mostly liquid, but gels behave like solids, for example, due to a three- dimensional cross-linked network within the liquid. A characteristic of a gel material is the high viscosity, as compared to that of a liquid material.

A liquid ink, which can be at room temperature, can be jetted onto a hot liquid. Upon contacting the hot surface, the liquid ink can gel, e.g., the viscosity of the liquid ink can change significantly from a liquid-like material to a jelly-like material. The gelled ink can resist against liquid dispersion, allowing the formation of a high resolution image on the liquid medium. The printing process can be performed using an automated printer having a movable printer head, such as an ink jet printer head loaded with a liquid ink. The printing process can be performed using a pen, e.g., a hand held device that can be controlled by an operator and that can dispense the liquid ink. The liquid ink can include a color agent.

In some embodiments, the present invention discloses liquid ink mixtures having hyperthermogelling components, and systems and methods to print on liquid media using the liquid ink mixtures. The liquid ink mixtures can include an aqueous phase change ink, which can contain a selected concentration of hyperthermogelling component, which can cause the ink to gel when its temperature increases to its thermo-inversion point. The ink may be jetted directly onto a heated liquid. The thermo-inversion point can be above the ambient temperature, such as the temperature of a hot beverage, e.g., between 50 and 100 C. The hyperthermogelling component can include a nonionic surfactant, such as an ethylene oxide propylene oxide block copolymer surfactant.

The phase change inks can exist in the liquid phase in an ink jet printing device. In operation, droplets of liquid ink can be ejected from the printing device. When the ink droplets contact the hot surface of the liquid medium, they can quickly solidify, e.g., converting to a gel state, to form a pattern of solidified, e.g., gelled, ink dots.

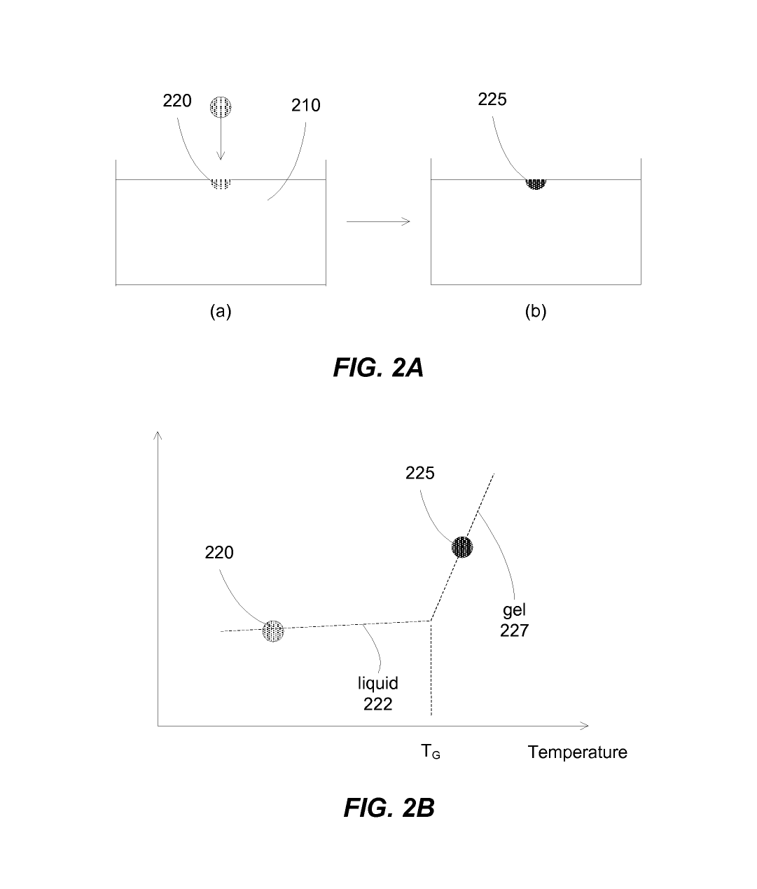

FIGS. 2A-2B illustrate schematic of printing using a phase change ink on a liquid medium according to some embodiments. In FIG. 2A, a liquid medium 210, such as a beverage drink disposed in a container, can be at a liquid temperature. For example, the liquid 210 can be a hot coffee drink, which is at a temperature, for example, between about 50 and 80 C. The liquid can be a beverage drink at a temperature between 0 and 100 C, such as a cold drink at temperatures between 0 and 10 C, a room temperature drink at temperatures between 15 and 30 C, a warm drink at temperatures between 30 and 50 C, or a hot drink at temperatures between 50 and 100 C.

A liquid ink droplet 220 can be dropped on the liquid medium 210, for example, from an ink jet printer. The temperature of the liquid ink 220 can be below the temperature of the liquid medium 210. For example, the liquid ink can be at room temperature for printing on hot liquid media. For cool liquid media, the liquid ink can be maintained at a cold temperature, for example, by a cooling mechanism.

Upon contacting the hotter liquid medium, the cooler liquid ink can gel, e.g., having a quick transition from a liquid state to a high viscosity state. The gelled ink droplet 225 can have minimal dispersion characteristics in the liquid medium 210, thus allowing the formation of a printed image.

FIG. 2B shows a transition characteristic of the liquid ink upon experiencing a high temperature, e.g., higher temperature than a gelling temperature T_{G} of the liquid ink. At low temperature, such as the temperature of the liquid ink stored in an ink jet printer head, the liquid ink 220 is at a liquid state 222. When the temperature of the liquid ink becomes higher than the gelling temperature T_{G}, such as when the liquid ink contacts the hot liquid medium, the liquid ink 225 transitions to a gel state 227.

In some embodiments, the present invention discloses methods and systems for printing aqueous inks on liquid substances with reduced image degradation. The aqueous inks can include phase change inks, which can contain containing liquid soluble compounds that exhibit thermo-inversion properties, e.g., compounds whose liquid solubility decreases as the solution temperature increases. Thus, when droplet ink solutions of these compounds are heated to their thermo-inversion points, they exhibit hyperthermogelling properties in which these compounds undergo a phase transition to turn the ink droplets into discrete, stable gels, e.g., ink gels.

Aqueous solutions of these hyperthermogelling compounds can have viscosity values dependent on their temperatures, e.g., at low temperatures, the aqueous solutions can have moderate viscosities and at high temperatures, the aqueous solutions can have high viscosities. Further, the viscosity values of these aqueous solutions can have a sharp transition at a critical temperature value. At the critical temperature, a small increase in the temperature of the solution can cause a rapid increase in viscosity, leading to complete gelling of the solution.

In some embodiments, the present invention discloses methods and systems for printing a liquid ink on a liquid medium, using phase change inks that gel instantly on contact with a relatively heated liquid medium, e.g., a liquid medium having a higher temperature than that of the phase change liquid ink.

Hyperthermogelling compounds can include homopolymers, copolymers, nonpolymeric surfactants, and their derivatives. Liquid ink compounds exhibiting this hyperthermogelling phenomenon can be used to print on liquid media at temperatures at, above, or below ambient temperature are preferred. For example, an ink composition of such a compound can be jetted at ambient temperature and gels instantly on an hot drink, such as a coffee drink, to produce un-dispersed ink dots.

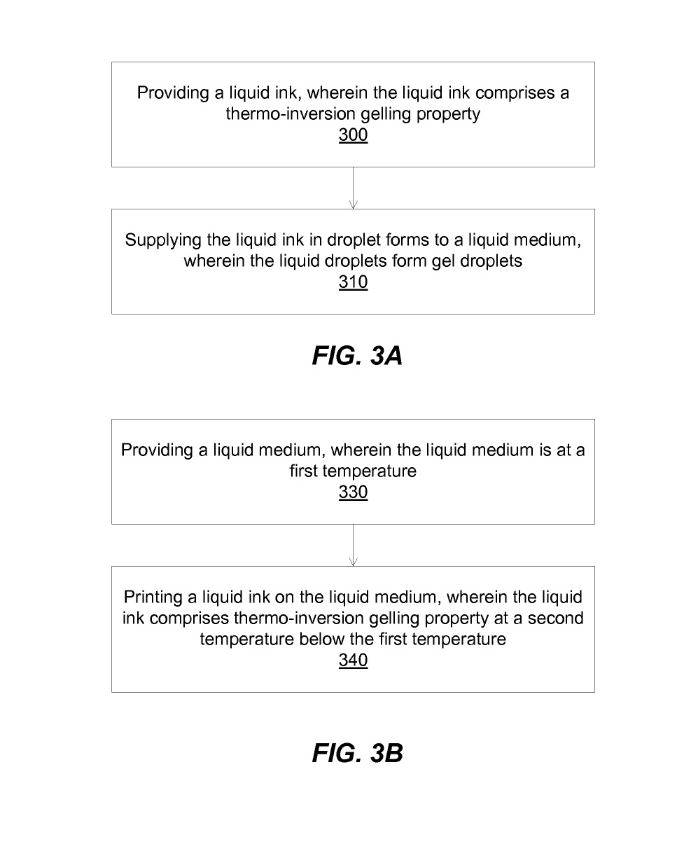

FIGS. 3A-3B illustrate flow charts for printing liquid phase change inks on liquid media according to some embodiments. FIG. 3A shows a basic operation of forming gel droplets in a liquid from liquid droplets. Operation 300 provides a liquid ink. The liquid ink can have a thermo-inversion gelling property. For example, a hyperthermogelling component can be mixed with a solvent, such as water to form a liquid ink solution. Color agents can be added to the liquid ink solution to form a liquid ink having a thermo-inversion gelling property. The concentration of the hyperthermogelling component can be based on the temperature of liquid medium that the liquid ink will be printed upon. For example, the concentration of the hyperthermogelling component in the liquid ink can be a concentration that the liquid ink can quickly gel upon contacting the hot liquid medium.

Operation 310 supplies the liquid ink in droplet forms to the liquid medium. Since the concentration hyperthermogelling component in the liquid ink is at concentration that allowing the liquid ink to gel at the temperature of the liquid medium, when the liquid droplets contact the liquid medium, the liquid droplets can form gel droplets.

FIG. 3B shows a basic operation for printing a liquid ink onto a liquid medium. Operation 330 provides a liquid at a first temperature. The liquid can be contained in a container. The liquid can be a liquid drink, such as coffee or tea. The liquid can be heated to the first temperature. The liquid can be prepared using a hot liquid at a temperature higher than the first temperature, such as using hotter water for brewing a hot coffee drink or a hot tea drink.

Operation 340 prints a liquid ink on the liquid surface. The liquid ink can be an edible ink for used with a liquid drink. The liquid ink can be a hyperthermogelling aqueous phase change ink at a critical concentration so that the liquid ink can turn into gel droplets upon contacting the hot liquid. For example, the liquid ink can have a thermo-inversion gelling property at a second temperature below the first temperature.

In some embodiments, the present invention discloses edible inks having a hyperthermogelling component, e.g., edible hyperthermogelling aqueous phase change ink. The hyperthermogelling aqueous phase change ink can include a nonionic surfactant, as disclosed in U.S. Pat. No. 5,462,591, which is incorporated by reference in its entirety, such as tetra-functional block copolymer surfactant terminating in primary hydroxyl groups such as ethylene oxide and propylene oxide, or an alkoxylated diamine. The nonionic surfactant can include a polyoxamine, having an alkyldiamine center (ethylene diamine, N—CH₂—CH₂—N), a hydrophobic core of y propylene oxide units, and hydrophilic end of x ethylene oxide units.

Numerous concentrations and combinations of these hyperthermogelling components may be employed. A variety of other components that exhibit hyperthermogelling properties may be used in ink compositions, such as homopolymers, copolymers, nonpolymeric or nonionic surfactants, naturally occurring polymers and their derivatives.

In some embodiments, the liquid ink drop may be jetted onto a liquid medium that is warmer than the thermo-inversion point of the ink composition. Contact with the warm liquid medium can instantly gel the ink drop. For example, a hyperthermogelling ink composition can be formulated to have a thermo-inversion point at a temperature below 30, below 40, or below 50 C. Such an ink composition could be jetted as a liquid at room temperature and would gel instantly after contacting a hot drink, such as a hot coffee or a hot tea drink, which has a temperature higher than the thermo-inversion point. The term “instantly gel” can mean that the liquid ink is gelled at a rate to prevent significant dispersion, such as less than a few seconds, e.g., less than 5, 2, or 1 seconds.

Alternatively, a hyperthermogelling ink composition can be formulated to have a thermo-inversion point at room temperature, e.g. between 15 and 30 C. The ink composition can be maintained as a liquid at a temperature below room temperature, and would gel instantly after contacting a liquid at room temperature.

Alternatively, a hyperthermogelling ink composition can be formulated to have a thermo-inversion point below room temperature, such as between 0 and 10 C. The ink composition can be maintained as a liquid at a temperature below this thermo-inversion temperature, and would gel instantly after contacting a cold liquid at temperatures between 0 and 10 C.

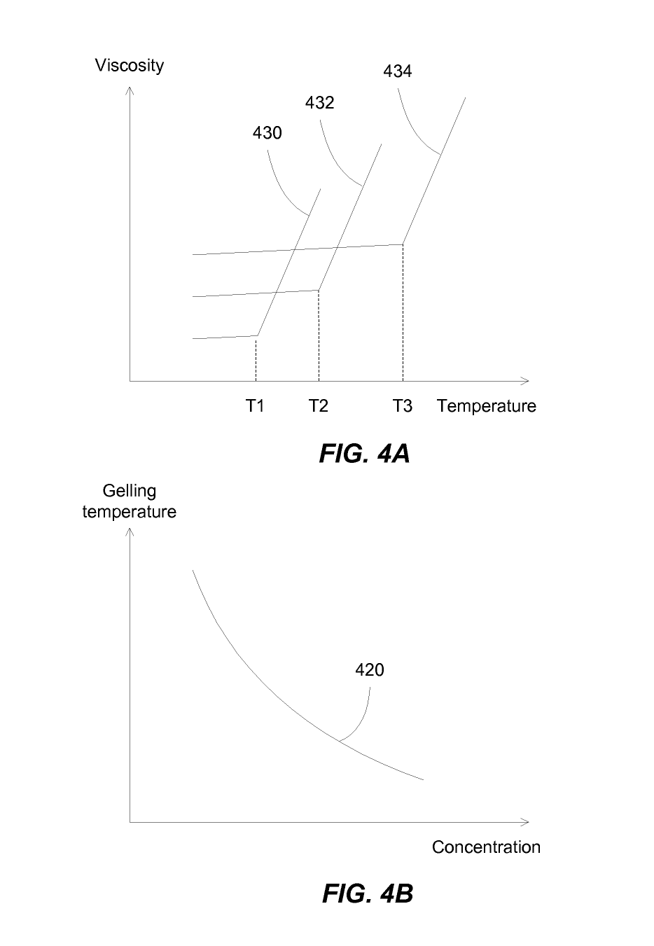

FIGS. 4A-4B illustrate properties of phase change inks according to some embodiments. FIG. 4A shows changes in viscosities as a function of temperature for different concentrations 430, 432, and 434 of a hyperthermogelling ink composition. At each concentration, the viscosity values can undergo a sharp transition at a transition temperature, e.g., transition temperature T1, T2, and T3 at concentrations 430, 432, and 434, respectively. Thus when a hyperthermogelling ink composition having concentration 430 is ink-jetted to a liquid having a temperature higher than the transition temperature T1, the ink can gel instantly, forming a sharp ink jet printed image with minimal liquid dispersion.

FIG. 4B shows a relationship 420 of composition concentrations and gelling temperatures, e.g., transition temperatures that the liquid composition becomes gel. High concentration of a hyperthermogelling component in a hyperthermogelling ink composition can exhibit a lower transition, e.g., gelling, temperature.

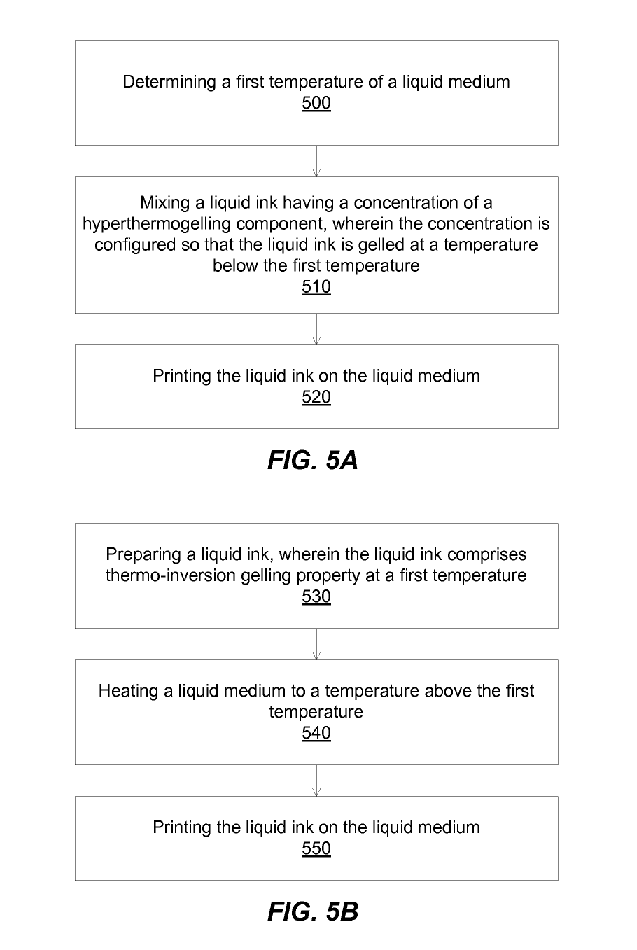

FIGS. 5A-5B illustrate flow charts for printing liquid phase change inks on liquid media according to some embodiments. In FIG. 5A, operation 500 determines a temperature of a liquid medium. Operation 510 mixes a liquid ink having a concentration of a hyperthermogelling component, wherein the concentration is configured so that the liquid ink is gelled at a temperature below the temperature. Operation 520 prints the liquid ink on the liquid medium.

In FIG. 5B, operation 530 prepares a liquid ink, wherein the liquid ink comprises thermo-inversion gelling property at a first temperature. Operation 540 heats a liquid medium to a temperature above the first temperature. This operation can mean to prepare a liquid medium at a temperature above the first temperature. Operation 550 prints the liquid ink on the liquid medium.

In some embodiments, the present invention discloses printers, and methods to use the printers, to print liquid inks on liquid surfaces. The printers can include ink jet printers, which can deposit droplets of liquid on a medium.

Ink jet printers can include an ink supply, e.g., a reservoir, for supplying inks to a nozzle head or a print head, at which the ink drops are ejected. Ink drop ejection can be controlled by a piezoelectric actuator. A piezoelectric actuator can include a piezoelectric material, which bends in response to an applied voltage. The bending of the piezoelectric layer pressurizes the ink to leave the nozzle head.

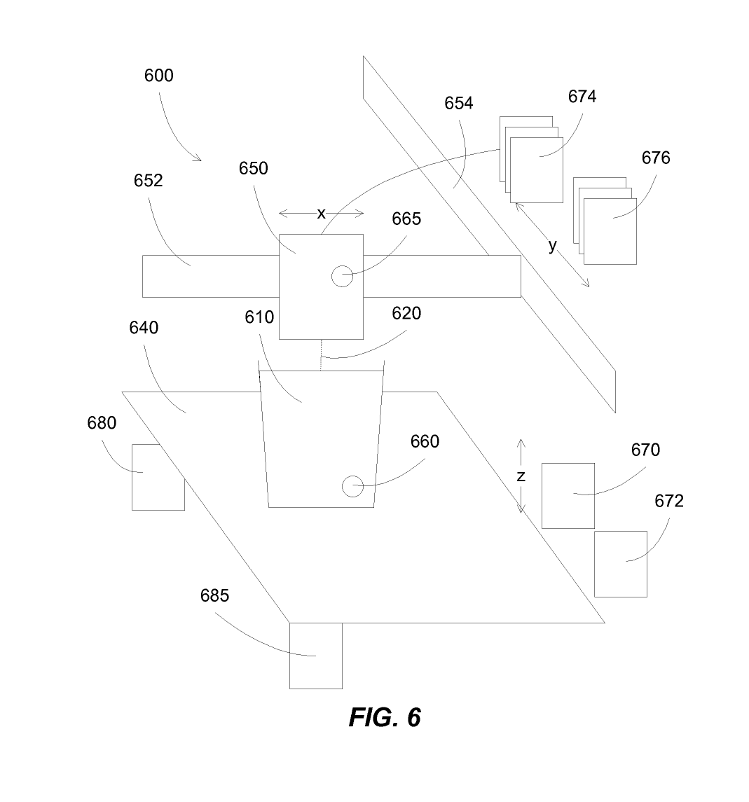

FIG. 6 illustrates a schematic of a printer for printing on a liquid according to some embodiments. The printer 600 can include a platform 640 for supporting a liquid container 610. The liquid container can have a liquid therein. The liquid can be filled to the rim, or can be partially filled, e.g., filled to a few cm from the rim, such as 1, 2, 5 or 10 cm. The platform 640 can move in a z direction, for example, up and down, to space the liquid container 610 from a printer head 650. The platform can move relative to the print head, for example, to bring the liquid container closer to the print head, the platform can move up or the print head can move down. A z mechanism 670 can be used to control the z movement of the platform or the print head. For example, the z mechanism can be coupled to the platform to move the platform up and down. Alternatively, the z mechanism can be coupled to the print head, e.g., to an assembly that includes the print head, to move the print head up and down.

In some embodiments, the platform can move so that the top surface of the liquid container is less than 10 mm or less than 5 mm from a bottom surface of the printer head 650. A distance sensor 665 can be coupled to the printer head, or to the printer head assembly, e.g., to the mechanism that moves the printer head. The distance sensor can be configured for sensing a distance from the printer head to the liquid surface. For example, the distance sensor can be a laser sensor or an ultrasonic sensor.

In some embodiments, an antivibration or damping mechanism 680 can be included. The antivibration or damping mechanism can be coupled to the platform to reduce vibration, for example, caused by movements of the moving mechanism, such as movements of the platform or movements of the print head assembly. The antivibration or damping mechanism can pacify the liquid surface of the liquid n the liquid container, allowing a flat and stationary surface for ease of printing.

In some embodiments, a heater 685 can be included. The heater can be coupled to the platform to heat the platform, which in turn, supplies heat to the liquid container for heating or for maintaining the temperature of the liquid. Alternatively, the heater can be coupled to the printer to provide a heated environment. For example, the printer can have an enclosure, and the heater can be placed inside the enclosure to heat the interior of the enclosure. The heater can be placed in the liquid container for heating the liquid.

A hot liquid can be used, e.g., a hot liquid in a liquid container is placed on the platform. The heater can be used to maintain the temperature of the liquid, for example, so that the liquid temperature is still higher than the gelling temperature of the phase change ink. A warm liquid can be used. The warm liquid can be heated to be above the gelling temperature before printing.

In some embodiments, a temperature sensor, such as a thermocouple sensor or an infrared sensor, can be used to measure the temperature of the liquid. Thus a liquid can be used, and the temperature sensor can be used to measure the temperature of the liquid. If the temperature is appropriate, e.g., above the gelling temperature, the printing can start. If the temperature is below the gelling temperature, the heater can be used to heat the liquid to temperature before starting the printing process.

The printer head 650 can move in lateral directions, such as x and y directions, or r and theta directions. For example, a moving mechanism 652 can be configured to move the printer head 650 in the x direction. A moving mechanism 654 can be configured to move the printer head assembly, e.g., the print head and the moving mechanism 652, in the y direction. Other moving mechanisms can be used, such as an x-y table configured to move the printer head. In addition, the platform can be stationary, with the printer head moves in the z direction. A controller 672 can be included to move the printer head according to a pattern for printing on the liquid surface. The printer can be loaded with hyperthermogelling phase change liquid ink.

Other components can be included, such as ink reservoirs 674 for different color inks, or ink reservoirs 676 for different temperature inks Different hyperthermogelling phase change liquid inks can be used to provide different gelling temperature. Same types of phase change liquid inks with different concentrations can be used to provide different gelling temperature. For example, a first reservoir can have a first phase change liquid ink at a first temperature, and a second reservoir can have a second phase change liquid ink at a second temperature. Thus the printer system can change the phase change inks depending on the liquid in the liquid container.

In some embodiments, an operator can place a liquid container on the platform, and then select the appropriate phase change ink. Alternatively, a temperature sensor 660, which can be coupled to the liquid in the liquid container 610, to measure the temperature of the liquid. A controller then can be used to determine the appropriate ink reservoir to supply to the print head for printing onto the liquid.

In operation, printer reservoirs containing liquid inks are connected to the printer head in the printer. A liquid container can be placed on the platform. The liquid can be at a temperature suitable for the printer ink, e.g., higher than the gelling temperature of the printer ink. If the temperature of the liquid is not suitable, the printer reservoirs can be replaced with other printer reservoirs that are suitable for the liquid on the platform. The temperature of the printer reservoirs can be controlled, so that it is lower than the temperature of the liquid.

The platform can move relative to the printer head so that the printer head is at a set distance from the liquid surface. The printer head can move according to a pattern to print on the liquid surface. Ink droplets 620 can be jetted to the liquid surface, and gelled instantly upon contacting the liquid.

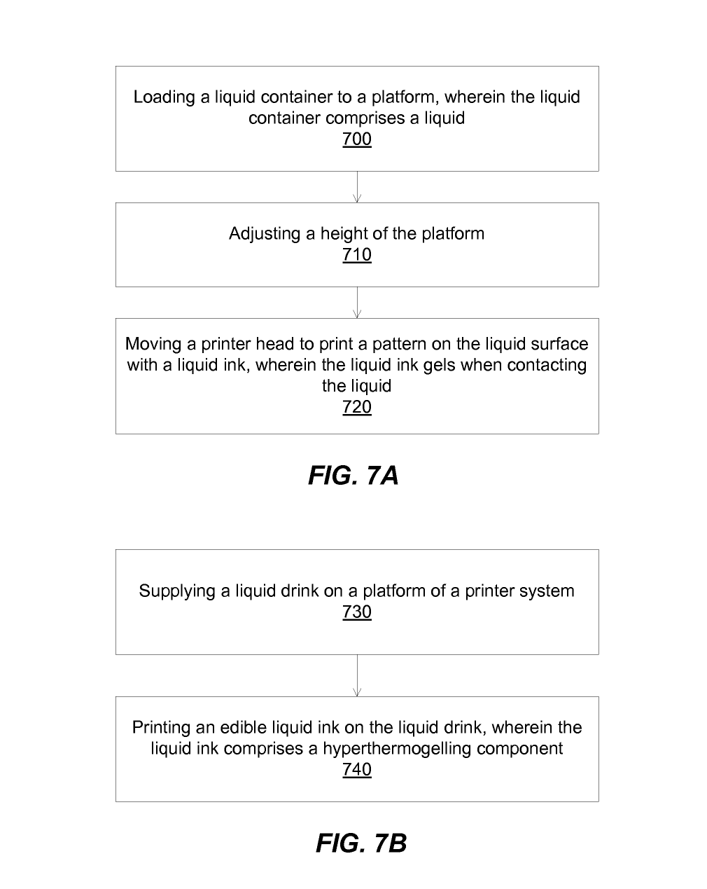

FIGS. 7A-7B illustrate flow charts for printing on liquid media according to some embodiments. In FIG. 7A, operation 700 loads a liquid container to a platform, wherein the liquid container comprises a liquid. Operation 710 adjusts a height of the platform. Operation 720 moves a printer head to print a pattern on the liquid surface with a liquid ink, wherein the liquid ink gels when contacting the liquid.

In FIG. 7B, operation 730 supplies a liquid drink on a platform of a printer system. Operation 740 prints an edible liquid ink on the liquid drink, wherein the liquid ink comprises a hyperthermogelling component.

In some embodiments, the present invention discloses liquid pens for writing on a liquid medium. The liquid pen can include an ink reservoir containing a hyperthermogelling component, and a nozzle for jetting the ink onto the liquid medium. A liquid pump can be used to bring the liquid ink from the ink reservoir to the nozzle. Alternatively, an ink jet assembly, using a piezo electric component, can be used for jetting the liquid ink to the liquid medium.

What is claimed is:

1. A method comprising
providing a first liquid having a first liquid surface and a first temperature;
supplying a second liquid on the first liquid surface, wherein the second liquid gels when contacting the first liquid;
moving the supplying of the second liquid so that the gelled second chemical liquid forms an image on the first liquid surface.

2. A method as in claim 1 further comprising
determining the first temperature;
adjusting a concentration of the second liquid so that the second liquid gels at or below the first temperature.

3. A method as in claim 1
wherein the first temperature is between 50 and 100 degrees Celsius.

4. A method as in claim 1
wherein the second liquid comprises a hyperthermogelling component,
wherein a concentration of the hyperthermogelling component is such that the second liquid gels at temperatures below the first temperature.

5. A method as in claim 1
wherein the second liquid comprises a thermo-inversion gelling property with a gelling temperature below the first temperature.

6. A method comprising
providing a container, wherein the container is at least partially filled with a liquid drink having a first liquid surface and a first temperature;
printing an image on the first liquid surface using an edible phase change ink, wherein the phase change ink is in a liquid state before printing, wherein the phase change ink is in a gel state after contacting the first liquid surface.

7. A method as in claim 6
wherein the first liquid surface is less than 5 mm from a rim of the container.

8. A method as in claim 6
wherein the first temperature is between 50 and 100 degrees Celsius.

9. A method as in claim 6
wherein the second liquid comprises a hyperthermogelling component,
wherein a concentration of the hyperthermogelling component is such that the second liquid gels at temperatures below the first temperature.

10. A method as in claim 6
wherein the second liquid comprises a thermo-inversion gelling property with a gelling temperature below the first temperature.

11. A method as in claim 6
wherein the phase change ink comprises a hyperthermogelling aqueous phase change ink.

12. A method as in claim 6
wherein the phase change ink comprises a gelling temperature based on a concentration of a hyperthermogelling component in the phase change ink.

13. A method as in claim 6 further comprising
adjusting a concentration of the phase change ink based on the first temperature so that the phase change ink changes phase when printed on the first liquid surface.

14. A method as in claim 6 further comprising
adjusting the first temperature so that the phase change ink changes phase on the first liquid surface.

15. A system for printing on a liquid surface of a liquid medium, the system comprising
a printer head;
a platform configured to support a container having the liquid medium;
a moving mechanism, wherein the moving mechanism is configured to move the printer head in x and y directions with respect to the platform;
a reservoir coupled to the printer head, wherein the reservoir is configured to supply an edible hyperthermogelling phase change liquid ink to the printer head, wherein the printer head is operable to supply the edible hyperthermogelling phase change liquid ink to the liquid surface, wherein a gelling temperature of the edible hyperthermogelling phase change liquid ink is lower than a temperature of the liquid medium.

16. A system as in claim 15 further comprising
a z mechanism, wherein the z mechanism is configured to move the platform relative to the printer head.

17. A system as in claim 15 further comprising
an antivibration or damping mechanism coupled to the platform to reduce vibration of the liquid surface of the liquid medium due to movements of the moving mechanism.

18. A system as in claim 15 further comprising
a sensor coupled to the liquid medium to measure a temperature of the liquid medium.

19. A system as in claim 15 further comprising
a sensor coupled to the printer head, wherein the sensor is configured for sensing a distance from the printer head to the liquid surface.

20. A system as in claim 15 further comprising
a second reservoir coupled to the printer head, wherein the second reservoir is configured to supply a second edible hyperthermogelling phase change liquid ink to the printer head, wherein a second gelling temperature of the second edible hyperthermogelling phase change liquid ink is different than the gelling temperature of the edible hyperthermogelling phase change liquid ink.
